(19) United States
(12) Patent Application Publication
(10) Pub. No.: US 2006/0010615 A1
(43) Pub. Date: Jan. 19, 2006

(54) Method for treating cellulosic grey fabric, products obtained by this process and their use

(76) Inventor: Hermanus Bernardus Maria Lenting, Oldenzal (NL)

Correspondence Address: NIXON & VANDERHYE, PC, 901 NORTH GLEBE ROAD, 11TH FLOOR, ARLINGTON, VA, 22203, US

(21) Appl. No.: 10/533,316

(22) PCT Filed: Oct. 30, 2003
(86) PCT No.: PCT/NL03/00742

§ 371 Date: Apr. 29, 2005

(30) Foreign Application Priority Data
Nov. 1, 2002 (NL) 1021820

(51) Int. Cl. C09B 67/00

(52) U.S. Cl. 8/401

(57) ABSTRACT

The invention relates to a method for treating a cellulosic grey fabric comprising the following steps: (a) a pretreatment step in which, in the presence of water, at a temperature of 60-100 DEG C., the fabric is contacted with a thermostable enzyme which degrades starch; and (b) an integrated desizing and scouring step in which, in the presence of water, at a temperature of 70 DEG C. at the most, the fabric as obtained in step (a) is contacted with an enzyme which degrades a polymeric component of the primary cell wall of cotton and an enzyme which degrades starch. The invention also relates to the use of fabric as obtained using the method of the invention for manufacturing textile products. The invention also provides fabric manufactured using the method of the invention. The invention further relates to textile products manufactured from fabric treated using the method of the invention.

The invention relates to a method for treating cellulosic grey fabric, comprising at least one pretreatment step (a) and one integrated desizing and scouring step (b), fabric obtained in this manner, the use of the treated fabric for manufacturing textile products, and textile products manufactured from the treated fabric.

The treatment of cellulosic grey fabric is essential in the manufacture of textile products. In order to make the threads spun from textile fibers stronger and to prevent thread breakage during weaving, prior to weaving, size, usually in the form of starch, is added to the threads. In this manner, the fabric threads are sized. However, after weaving, starch needs to be removed from the grey fabric obtained because it has an adverse effect on the further treatment steps of the fabric obtained. Such a desizing traditionally took place by treating the fabric with relatively low concentrations of NaOH for a longer period, often a few hours, at a temperature of 60° C. at the most. After the desizing step, the fabric obtained subsequently needs to be subjected to a scouring step in order to make the fabric hydrophihc. This is necessary because all further treatments of the fabric, such as bleaching and dyeing, are usually designed on a water basis, and the desized fabric still comprises contaminations such as inter alia pectin, protein, organic acids, fatty acids and waxes (lubricant), which form a hydrophobic layer around each textile fiber in the fabric. It is known to carry out this scouring step at a temperature of 80-100° C. using high concentrations of NaOH. However, such a scouring step has the disadvantage that not only contaminations are decomposed but that the chain lengths of the cellulose polymers in the fabric become smaller as well, so that the tensile strength of the fabric is reduced and damages in the fabric occur and/or desired properties of the fabric cannot be realized.

Further, it should be noted that such desizing and scouring steps are not environmentally friendly, and, due to the great salinity of the wastewater released in large volumes, the water purification plants are more heavily loaded.

To solve these problems, desizing and scouring steps have been developed in which use is made of enzyme technology instead of NaOH. When starch is used as a size, the enzymatic desizing step can be carried out using, for instance, an α-amylase, by means of which the starch is hydrolyzed. The hydrolyzed starch can then be washed away before it is subjected to a scouring step. This whole desizing process including washing involves at least 20 minutes. In an enzymatic scouring step, contaminations already mentioned above such as pectin, protein, organic acids, fatty acids and waxes (lubricant) present in the textile fibers are degraded, after which all components to be washed away can then be washed away. The removal of these components helps to improve the quality of the fabric. With regard to the scouring step, in this context, reference can be made to patent publication WO 98/24965, in which a fabric is subjected to a scouring step in which, at a lowered temperature, an enzyme solution is used which contains pectinase, which enzyme effects the hydrolysis of pectin.

In practice, however, a combination of enzymatic desizing and scouring steps carried out serially has the disadvantage that the whole treatment has a minimum duration of 40 minutes. However, the two enzymatic processes for both desizing and scouring of the grey fabric can be integrated if the enzymes used are active in the same temperature and pH range. Then, the process duration of such an integrated enzymatic process is equal to the duration of the longest individual process, namely at least 20 minutes, including the subsequent washing of the thus treated fabric.

For the use of such an integrated process in a continuously operating machine, at a normal fabric rate of at least 1 meter/second, this means that, continuously, at least 1200 meters of fabric are in this process stage. It will be clear that such process designs take much time, and one cannot easily and rapidly change over from the treatment of one type of fabric to the treatment of a different type of fabric, using the same equipment. However, flexibility in the fabric to be continuously treated is very important nowadays, given the generally rapidly changing demand for different types of fabric in the clothing industry and the increasingly smaller quota of a particular type of fabric to be produced. The demand for particular types of fabric may be great today, but may be completely different tomorrow. Therefore, textile manufacturers need to be extremely flexible and they need to be able to quickly adjust their treatment processes in order to be able to treat different types of fabric.

Surprisingly, it has now been found that, using the combination of a specific pretreatment step and an integrated enzymatic desizing and scouring step, high-quality fabric can be obtained in an extremely short period of time, usually 3 to 6 minutes.

The invention thus relates to a method for treating a cellulosic grey fabric comprising the following steps:
(a) a pretreatment step in which, in the presence of water, at a temperature of 60-100° C., the fabric is contacted with a thermostable enzyme which degrades starch; and
(b) an integrated desizing and scouring step in which, in the presence of water, at a temperature of 70° C. at the most, the fabric as obtained in step (a) is contacted with an enzyme which degrades a polymeric component of the primary cell wall of cotton and an enzyme which degrades starch.

The method according to the invention does not only realize a considerable saving of time, which achieves a large degree of flexibility in the continuous treatment of small batches of different types of fabric, as such, it is also more environmentally friendly, and the equipment to be used no longer needs to be corrosion-resistant.

Preferably, between steps (a) and (b), the fabric is subjected to a treatment in which the mass transport of textile fiber components to be washed away, such as starch, is promoted. Such a measure effects the removal of such components and reduces the total treatment time even further. Such a treatment can be a vacuum treatment or a blowing treatment.

Preferably, in steps (a) and (b), the enzyme which degrades starch is an amylase, more preferably an α-amylase.

The enzyme to be used in step (b) which degrades a polymeric component of the primary cell wall of cotton is preferably chosen from the group of cellulase, protease and/or pectinase. Also, in step (b), a lipase can be used which degrades the hydrophobic triglycerides in the primary cell wall. More preferably, this enzyme is a pectinase. A very suitable pectinase is polygalacturonate lyase (pectate lyase).

In the two steps (a) and (b), different types of enzymes can be used which degrade starch. In step (b), different types of enzymes can be used which degrade a polymeric component of the primary cell wall of cotton. Suitable amylases which can be used in the method according to the invention are α-amylases.

Preferably, in step (a), an α-amylase is used and in step (b), an α-amylase and a pectinase are used.

The cellulases to be used can be chosen from the group of exoglucanases and endoglucanases. The proteases which can be used according to the invention can be chosen from the group of serine peptidases, carboxypeptidases and thiol proteases. Suitable pectinases are those which can be chosen from the group of protopectinases, polymethyl and polygalacturonate lyases, and polymethyl and polygalacturonases. Preferably, polymethyl or polygalacturonate lyase (pectate lyase) is used.

The lipases to be used can be obtained from, for instance, milk, yeast, bacteria and animals. Other suitable amylases, cellulases, proteases and pectinases which can be used according to the invention are mentioned in patent publication U.S. Pat. No. 6,436,696.

Step (a) is preferably carried out at a temperature of 70-100° C., more preferably at 80-100° C., and most preferably at 90-100° C., while step (b) is preferably carried out at a temperature of 30-60° C., and more preferably at 45-55° C. These temperature ranges comprise both the limit values mentioned above and below. The upper limit value is determined by the stability of the enzymes used. When the enzymes to be used are stable at higher temperatures, these higher temperatures apply. When a pectinase is available which is active and stable at a temperature in the range as it is used in step (a), steps (a) and (b) can be integrated into one step.

Steps (a) and (b) can both be carried out in an acid environment as well as an alkaline environment. In practice, steps (a) and (b) usually involve working at or near a pH at which the respective enzyme has an optimum activity. Preferably, steps (a) and (b) are carried out at a pH of 7.5-9.5, more preferably at a pH of 8.5-9.0. At the start of step (a) and/or step (b), the pH may possibly be outside the limit ranges mentioned, while the pH moves into these limit ranges during the treatment of the fabric. In order to ensure that the pH remains inside the limit range in which the desired enzyme activity occurs, in steps (a) and (b), preferably, a buffer is used in the aqueous solution. In practice, such an amount of buffer is used that the pH is and stays within the desired limit range for the duration of the process. Choosing a suitable buffer for the desired pH range will pose no problem to a person skilled in the art. Use can be made of both inorganic and organic buffers. Suitable buffers can, for instance, be made using sodium phosphate, potassium phosphate, sodium carbonate, sodium bicarbonate, sodium citrate, sodium acetate, ammonium acetate, potassium hydrogen phthalate and sodium acetate.

In a suitable embodiment, in step (a), an amylase, preferably an α-amylase, is used which has a total enzyme activity of 2,000-15,000 RAU per liter of medium. A RAU (Reference Amylase Unit) is an activity unit as defined by Genencor International. The activity of the enzyme is measured against an internal standard using a synthetic starch substrate: a blocked p-nitrophenyl maltoheptaside. Preferably, in step (a), the enzyme has a total enzyme activity of 5,000-8,000 RAU per liter of medium.

In step (b), the amylase enzyme to be used, preferably α-amylase, has a total enzyme activity of 2,000-15,000 RAU per liter of medium, more preferably a total enzyme activity of 5,000-8,000 RAU per liter of medium.

In a suitable embodiment, in step (b), the pectinase enzyme, preferably pectate lyase, is used in a total enzyme dose of 1-1500 APSU/l, and preferably 10-25 APSU/l. The APSU (Alkaline Pectinase Standard Unit) unit is defined by Novo Nordisk and described in their analytical method description EB-SM-0419.02.

The aqueous solutions to be used in steps (a) and (b) can also contain a surfactant. Preferably, both steps (a) and (b) are carried out using an aqueous solution in which a surfactant is present as well. Suitable surfactants, which need to be compatible with the enzymes to be used, can be chosen from the group of anionic, non-ionic and cationic surfactants. Suitable examples are tergitol, the triton X series, the tween series, alkyl sulphonates, and quaternary nitrogen compounds. The concentration of the surfactant in steps (a) and (b) is preferably 0.1-1.0 gram per liter of the aqueous solution to be used, and more preferably 0.4-0.7 gram per liter of the aqueous solution to be used.

A major and surprising result of the invention is that the treatment of grey fabric can be carried out much more rapidly than was the case so far, by integration of the desizing and scouring steps and the introduction of a pretreatment which is carried out at a high temperature. In a suitable embodiment of the method according to the invention, steps (a) and (b) are carried out as a continuous process and the fabric is subjected to each step for 5 minutes at the most. Preferably, the steps (a) and (b) are carried out as a continuous process in which the fabric is subjected to each step for 0.5-2.5 minutes.

In a suitable embodiment, the fabric obtained in step (b) is then subjected to a washing treatment at a temperature of 60-100° C. and in the presence of water and a surfactant. Suitable surfactants can be chosen from the group of anionic, non-ionic and cationic surfactants. Suitable examples are tergitol, the triton X series, the tween series, alkyl sulphonates, and quaternary nitrogen compounds. Preferably, this washing treatment is carried out at a temperature of 80-100° C., more preferably at 90-100° C. The washing treatment is preferably carried out in the presence of a compound which binds metal ions (chelating agent). Suitable chelating agents can be chosen from the group of EDTA, EGTA, imidodisuccinate and other substances which form a complex with metal ions.

Between step (b) and the subsequent washing treatment, the fabric is preferably subjected to a treatment in which the mass transport of textile fiber components to be washed away is promoted. Such a measure effects the removal of degraded and other textile fiber components, such as pectin, and reduces the total treatment time even further. Such a treatment can be a vacuum treatment or a blowing treatment. The washed fabric can then be subjected once more to a washing treatment before it is bleached. Such a washing treatment can be carried out under conditions equal to or milder than the previous washing treatment. Between the washing treatments, also, a treatment can be carried out in which the mass transport of textile fiber components to be washed away is promoted. Also, the fabric can be bleached between the two washing treatments or before the two washing treatments.

The fabric can be bleached using, for instance, hydrogen peroxide or another suitable bleaching agent in order to obtain a white fabric which can then be dyed in a desired color. Depending on the final purpose of the fabric, then, the different chemicals can be applied on the fabric, for instance, to make the fabric dirt-resistant or fire-retardant.

Preferably, the cellulosic grey fabric is a woven grey cotton fabric. In addition to cotton fibers, such a fabric can also contain other fibers such as, for instance, polyester, polyamide, viscose or lyocell fibers.

Using the method according to the invention, the fabric can be treated in the form of either a broadcloth or a strand. Preferably, the fabric is treated in the form of a broadcloth.

Both the pretreatment and the integrated desizing and scouring step need to take place in equipment where the fabric to be treated can contact the aqueous medium containing the enzymes and other chemicals and where the temperature can be maintained constant. This can take place in a thermostated J-box. In this manner, the broadcloth can be treated particularly rapidly. Preferably, the J-box is provided with a thermostat so that the temperature can be regulated.

The invention also relates to the use of fabric as obtained using the method of the invention for manufacturing textile products.

The invention also provides fabric obtainable using the method of the invention. This is high-quality fabric which can be characterized by the fact that the natural degree of polymerization of cellulose as present in the cotton fiber is left virtually completely intact in this process. Consequently, the tensile strength of fabric as treated using the method of the invention described herein is optimal and is superior to that of fabric treated by means of the conventional scouring process using sodium hydroxide solution. The result is that this fabric will have a longer life than fabric obtained using the conventional scouring process.

The invention further relates to textile products manufactured from textile fibers obtainable using the method of the invention.

### EXAMPLE 1

Grey fabric of 100% cotton sized with starch, having a fabric weight of 120 g/cm², was pretreated in a Linie tester for 1 minute at a temperature of 95° C. in a medium consisting of: 200 ml of 25 mM phosphate buffer pH 9.0 containing 0.5 g/l of Tergitol 15-S-12 and 0.9 g/l of Optisize HT40. After the pretreatment, the fabric was directly briefly (15 sec) vacuumed and then subjected to a scouring step. In this step, the fabric was treated in the Linie tester for 1 minute at 55° C., using the same buffer as in the pretreatment step, with this difference that, here, additionally, 5 ml/l of Baysolex 20022 (pectate lyase; formulated product of Bayer, enzyme itself is ex Novozymes) had been added. After this scouring step, the fabric was subjected to a vacuum treatment and then washed for 15 sec in 200 ml of water, with 0.5 g/l of Tergitol 15-S-12 and 1 mM of EDTA dissolved therein, at a temperature of 95° C. After this, again, a vacuum treatment was used, after which the fabric was washed again, now with mere water of 70° C. (200 ml), again for 15 sec. Then, the fabric obtained was air-dried and conditioned for at least 24 hours at 20° C./65% atmospheric humidity.

The results of the evaluation of the treated fabric are shown in Table 1. The wettability of the fabric was measured using the drop method, in which it is determined how much time it takes for a drop of water to be absorbed by the fabric; this is a measure for the hydrophilicity. The residual pectin content was determined using Ruthenium Red stain according to a method described by Novozymes' standard operational procedure document EUS-SM-0103.02/01. Residues of the starch on the fabric were analyzed by staining the starch with an iodine solution (solution containing 2.4 g/l of KI and 1.3 g/l of 12) and classifying the degree of staining as shown in Table 1.

It can be concluded from the results that both the hydrophilicity of the fabric and the residual presence of the starch are at a favorable level. From the fact that pectin can still be detected on the fabric, it can be derived that not the complete primary cell wall of cotton has been removed.

### EXAMPLE 2

The process as described in Example 1 was carried out again except that the fabric was not subjected to the various vacuum treatments. The results are shown in Table 2. The positive effect of the vacuum treatments can clearly be seen in the results obtained.

### EXAMPLE 3

The process as described in Example 1 was carried out again with the difference that the fabric was not subjected to the pretreatment step, but was, by contrast, subjected to the integrated desizing and scouring step for 2 minutes.

The evaluation results of this process and that of Example 1 are shown in Table 3. The results clearly show that the pretreatment step has a positive effect on the removal of starch, it being noted that, in both processes, the fabric is treated with enzymes for a same period of time. Further, it can be noted that, in the process with the pretreatment step, a significantly better hydrophilicity is obtained, despite the fact that the incubation with pectinase takes twice as long in the situation without a pretreatment step.

### EXAMPLE 4

The process as described in Example 1 was carried out again several times with these differences that the pretreatment step was carried out for 2 minutes in the presence of 1 mM of EDTA and both with and without α-amylase; no vacuum treatments took place; the fabric was subjected to the integrated desizing and scouring step for 2 and 10 minutes respectively; and the duration of both washing steps was 15 minutes. The evaluation results are shown in Table 4. The positive effect of the presence of α-amylase in the pretreatment step is very clear when the results of the process in which α-amylase is used in the pretreatment step and the integrated desizing and scouring step is carried out for 2 minutes are compared to those of the process in which no α-amylase is used in the pretreatment step and the integrated desizing and scouring step is carried out for 10 minutes.

TABLE 1

| analysis | result |
|---|---|
| wettability | <1 sec |
| residual pectin | 19% |
| presence of starch | 0/—* |

*—= no starch detectable on the fabric
0= virtually no starch detectable anymore, acceptable
+ = starch still slightly detectable
++ = starch still clearly detectable
+++ = substantial amount of starch detectable

TABLE 2

| | result | |
|---|---|---|
| analysis | with vacuum treatment | without vacuum treatment |
| wettability | <1 sec | <1 sec |
| residual pectin | 20% | 19% |
| presence of starch | 0/—* | +* |

*denotation see Table 1

TABLE 3

result

| analysis | with pretreatment | without pretreatment |
|---|---|---|
| wettability | <1 sec | <1 sec |
| residual pectin | 20% | 23% |
| presence of starch | 0/—* | +* |

*denotation see Table 1

TABLE 4

| | result | | |
|---|---|---|---|
| | α-amylase in | 2 min | 10 min |
| analysis | pretreatment step | scouring step | scouring step |
| residual | — | 19% | 17% |
| pectin | + | 17% | 17% |
| presence of | — | +++ | ++ |
| starch* | + | +/0 | +/0 |

*denotation see Table 1

1. A method for treating a cellulosic grey fabric, comprising the following steps:
(a) a pretreatment step in which, in the presence of water, at a temperature of 60-100° C., the fabric is contacted with a thermostable enzyme which degrades starch; and
(b) an integrated desizing and scouring step in which, in the presence of water, at a temperature of 70° C. at the most, the fabric as obtained in step (a) is contacted with an enzyme which degrades a polymeric component of the primary cell wall of cotton and an enzyme which degrades starch.

2. A method according to claim 1, wherein, between steps (a) and (b), the fabric is subjected to a treatment in which the mass transport of fabric components to be washed away is promoted.

3. A method according to claim 2, wherein the treatment is a vacuum treatment or a blowing treatment.

4. A method according to claim 1, wherein, in steps (a) and (b), the enzyme which degrades starch is an amylase.

5. A method according to claim 4, wherein, in steps (a) and (b), the enzyme which degrades starch is an α-amylase.

6. A method according to claim 1, wherein, in step (b), the enzyme which degrades a polymeric component of the primary cell wall of cotton is chosen from the group of cellulase, protease and/or pectinase.

7. A method according to claim 6, wherein, in step (b), the enzyme which degrades a polymeric component of the primary cell wall of cotton is a pectinase.

8. A method according to claim 7, wherein the pectinase is a polygalacturonate lyase.

9. A method according to claim 1, wherein steps (a) and (b) are carried out in the presence of a surfactant.

10. A method according to claim 1, wherein step (a) is carried out at a temperature of 80-100° C.

11. A method according to claim 10, wherein step (a) is carried out at a temperature of 90-100° C.

12. A method according to claim 1, wherein step (b) is carried out at a temperature of 30-60° C.

13. A method according to claim 1, wherein steps (a) and (b) are carried out at a pH of 7.5-9.5.

14. A method according to claim 1, wherein steps (a) and (b) are carried out as a continuous process and the fabric is subjected to each step for 5 minutes at the most.

15. A method according to claim 1, wherein the fabric obtained in step (b) is subjected to a washing treatment which is carried out at a temperature of 60-100° C. in the presence of a surfactant.

16. A method according to claim 15, wherein, between step (b) and the subsequent washing treatment, the fabric is subjected to a treatment in which the mass transport of fabric components to be washed away is promoted.

17. A method according to claim 16, wherein the washed fabric is subsequently bleached.

18. A method according to claim 1, wherein the fabric is a woven cotton fabric.

19. Fabric manufactured according to the method of claim 1.

20. Use of a fabric as obtained using the method according to claim 1 for manufacturing textile products.

21. A textile product manufactured from a fabric treated using the method according to claim 1.
